(19) United States
(12) Patent Application Publication
(10) Pub. No.: US 2008/0176524 A1
(43) Pub. Date: Jul. 24, 2008

(54) FM transmitter device

(75) Inventors: Yukinaga Koike, Azumino-city (JP); Yuichi Miyashita, Azumino-city (JP)

Correspondence Address: KRATZ, QUINTOS & HANSON, LLP, 1420 K Street, N.W., Suite 400, WASHINGTON, DC, 20005, US

(73) Assignee: CIRCUIT DESIGN INC., Azumino-city (JP)

(21) Appl. No.: 12/007,631

(22) Filed: Jan. 14, 2008

(30) Foreign Application Priority Data
Jan. 18, 2007 (JP) 2007-8869

(51) Int. Cl. H04B 1/04

(52) U.S. Cl. 455/110

(57) ABSTRACT

An FM transmitter device having an audio signal processing compression unit for logarithmically compressing an audio signal, an FM broadband transmission single chip IC receiving as inputs a modulated signal from the audio signal processing compression unit and a channel frequency setting signal C, operating upon receipt of a reference clock, and transmitting an FM high frequency wave, a SAW resonator configuring a locally oscillator, a 700 MHz band SAW oscillation circuit, a mixing circuit for mixing the non-modulated high frequency wave from this oscillation circuit and the FM high frequency wave from the FM broadband transmission single chip IC and converting the frequency, and a SAW filter for eliminating an unrequired frequency among mixed waves from the mixing circuit and extracting a high frequency component in the 200 MHz band or the 800 MHz band, whereby an FM transmitter device which is small in size and lower in power consumption and can obtain a high S/N ratio is provided.

### BACKGROUND OF THE INVENTION

1. Field of the Invention

The present invention relates to an FM transmitter device suitable for use in a wireless microphone (radio mike) device, a wireless transmitter device, and so on.

2. Background of the Invention

Due to the Radio Wave Law in Japan or in other countries, in general, most wireless microphone devices operate in the vicinity of the 200 MHz band or the 800 MHz band. PLL frequency synthesizer systems enabling the channel frequency to be freely set within a permissible band are being widely used. Among these systems, in the “straight” system using a VCO (voltage controlled oscillator) operating in the 200 MHz band or the 800 MHz band, the frequency of the FM high frequency wave from the VCO and a transmission frequency from an antenna are in the same 800 MHz band, therefore feedback arises on the electronic circuit in the VCO from the antenna to cause a coupling, and fluctuation occurs in the frequency when a hand touches the antenna. For this reason, the measure has been devised of inserting an isolator between a transmission output stage and the antenna to reduce an S parameter reflection coefficient (S11) and, at the same time, inserting an attenuator into each stage of a transmission amplifier circuit to increase a degree of amplification in a forward direction and thereby improve the reflection characteristic. However, the power emitted from the antenna is coupled with the VCO via the space, so the fluctuation of frequency still occurs. Therefore, it was necessary to shield the VCO and then shield the entire transmission circuit. This led to the trouble of double sealing and a larger size. Further, after the VCO, attenuation and amplification are alternately carried out; therefore the power consumption is large.

On the other hand, in a multiplication system using a VCO and 2-multiplier circuit etc. operating in the 100 MHz band or the 400 MHz band, the coupling of the antenna and the VCO is reduced, the fluctuation of the frequency can be suppressed, and the load of shielding is reduced.

Turning now to the problem to be solved by the invention, in the multiplication system, the phase noise generated in the VCO is multiplied by the multiplier circuit, therefore deterioration of the S/N ratio is caused.

### SUMMARY OF THE INVENTION

Therefore, in consideration of the problems described above, an object of the present invention is to provide an FM transmitter device which is made smaller in size and lower in power consumption and can obtain a high S/N ratio.

An FM transmitter device according to the present invention comprises an FM broadband transmission single chip IC which operates by receiving as its inputs a modulated wave based on an audio signal and a carrier wave setting signal, and an oscillator, wherein a non-modulated high frequency wave obtained from either of the FM broadband transmission single chip IC and the oscillator and an FM high frequency wave obtained from the other at a mixing circuit are mixed to generate a mixed wave, an unrequired frequency from this mixed wave is eliminated by a filter means, and thereby a transmission FM wave of the 200 MHz band (VHF) or the 800 MHz band (UHF) is generated.

Note that, the “200 MHz band” means a band including also frequencies in the vicinity of 200 MHz, and the “800 MHz band” means a band including also frequencies in the vicinity of 800 MHz and permitted for a wireless microphone device etc.

As the FM broadband transmission single chip IC, use can be made of a commercially available product (for example Model No. BH1425 made by Rohm Co., Ltd.), therefore not only can a smaller size and lower power consumption be naturally achieved, but also, unlike with the straight system or the multiplication system, the mixing circuit mixes the non-modulated high frequency wave and the FM high frequency wave to generate the mixed wave, then, after the frequency conversion in this mixing circuit, the unrequited frequency is eliminated by the filter means to generate the transmission FM wave of the 200 MHz band or the 800 MHz band, so a smaller size and lower power consumption and a high S/N ratio can be obtained.

In the frequency conversion in the mixing circuit, sometimes the oscillator is utilized as a local oscillator outputting a non-modulated high frequency wave and sometimes the FM broadband transmission single chip IC is utilized as a local oscillator outputting a non-modulated high frequency wave. In the former case, the non-modulated high frequency wave is an oscillation wave obtained from the oscillator. The FM high frequency wave becomes a modulated wave obtained from the FM broadband transmission single chip IC, but in the latter case, the non-modulated high frequency wave is a carrier wave obtained from the FM broadband transmission single chip IC not receiving as input the modulated wave and, at the same time, receiving as input the carrier wave setting signal. The FM high frequency wave becomes a modulated wave obtained by analog changing the additional capacity of the oscillator by the modulated wave based on the audio wave.

Here, desirably the oscillator is a SAW resonator oscillator. A low jitter oscillator such as a crystal oscillator may also be used when a transmitting FM wave of the 200 MHz band is generated. Further, the filter means serving as the band pass filter is desirably a SAW filter.

According to the present invention, an FM transmitter device which is small in size and lower in power consumption and can give a high S/N ratio can be provided.

### BRIEF DESCRIPTION OF THE DRAWINGS

These and other objects and features of the present invention will become clearer from the following description of the preferred embodiments given with reference to the attached drawings, wherein:

FIG. 1 is a block diagram showing an FM transmitter device according to a first embodiment of the present invention,

FIG. 2 is a block diagram showing an FM transmitter device according to a second embodiment of the present invention, and

FIG. 3 is a block diagram showing an FM transmitter device according to a third embodiment of the present invention.

### DESCRIPTION OF THE PREFERRED EMBODIMENTS

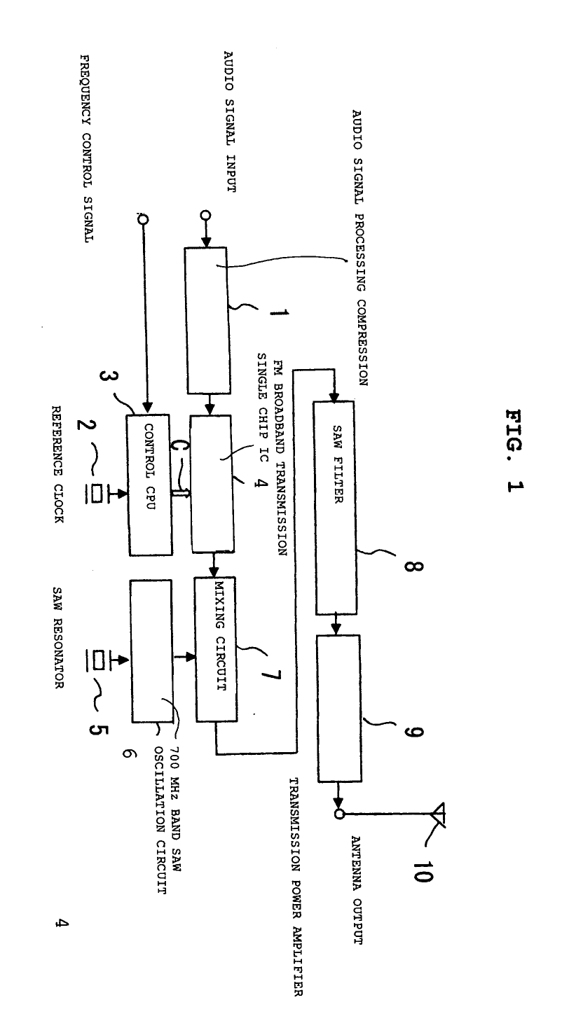

Next, an explanation will be given of embodiments of the present invention based on the attached drawings. FIG. 1 is a block diagram showing an FM transmitter device according to a first embodiment of the present invention.

This FM transmitter device can be applied to a wireless microphone (radio mike) device of the PLL frequency synthesizer system, a wireless use FM transmitter device, and so on and has an audio signal processing compression unit 1 for logarithmically compressing the audio signal from the microphone etc., a clock generation oscillator 2 for generating a reference clock, a control CPU 3 outputting a channel frequency setting signal C by a frequency control signal upon receipt of the reference clock, an FM broadband transmission single chip IC 4 receiving as inputs the modulated signal from the audio signal processing compression unit 1 and the channel frequency setting signal C, operating upon receipt of the reference clock, and transmitting the FM high frequency wave (modulated wave) in the 78 MHz to 108 MHz band, a SAW resonator (surface acoustic wave generation element) 5 configuring the locally oscillator, a 700 MHz band SAW oscillation circuit 6, a mixing circuit 7 for mixing the non-modulated high frequency wave from this oscillation circuit 6 and the FM high frequency wave from the FM broadband transmission single chip IC 4 and converting the frequency, a SAW filter 8 serving as a band pass filter for eliminating the unrequired frequency (DC component, beat frequency component, second harmonic component, etc.) in the mixed wave from the mixing circuit 7 and extracting the high frequency component (transmission FM wave) in the 800 MHz band (778 MHz to 808 MHz), a transmission power amplifier 9 for amplifying the power of this high frequency component, and an antenna 10 for emitting the wave. As the FM broadband transmission single chip IC 4 outputting the FM high frequency wave, use is made of a commercially available product (for example Model No. BH1425 made by Rohm Co., Ltd.) having a built-in pre-emphasis circuit, limiter circuit, LPF, PLL frequency synthesizer, etc.

Since the FM broadband transmission single chip IC 4 is used, a smaller size and lower power consumption can be achieved. In addition, the non-modulated high frequency wave and the FM high frequency wave are mixed in the mixing circuit 7 to generate the mixed wave, and, after the frequency conversion at this mixing circuit 7, the unrequired frequency is eliminated by the SAW filter 8 and the transmission FM wave in the 800 MHz band is generated, therefore a smaller size and lower power consumption and a high S/N ratio are obtained.

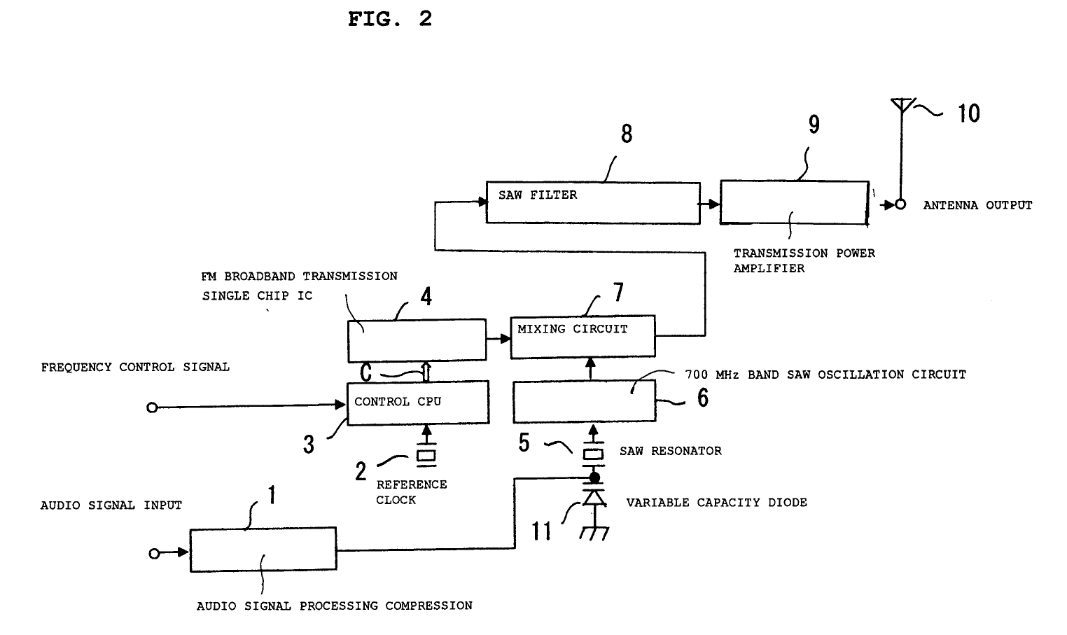

FIG. 2 is a block diagram showing an FM transmitter device according to a second embodiment of the present invention. In FIG. 2, the same notations are attached to portions the same as the portions shown in FIG. 1, and the explanations thereof are omitted.

The point of difference of the present embodiment from the first embodiment resides in that the FM broadband transmission single chip IC 4 is used as the oscillator for oscillating the non-modulated high frequency wave, therefore the modulated signal from the audio signal processing compression unit 1 is not input, but the non-modulated high frequency wave is output to the mixing circuit 7. At the same time, a variable capacity diode 11 is connected to the SAW resonator 5, an additional capacity thereof is analog changed by the modulated signal from the audio signal processing compression unit 1, and the FM high frequency wave is output as the modulated wave from the 700 MHz band SAW oscillation circuit 6 to the mixing circuit 7.

In the present embodiment as well, an FM broadband transmission single chip IC 4 is used, therefore a smaller size and lower power consumption can be achieved. In addition, the non-modulated high frequency wave and the FM high frequency wave are mixed in the mixing circuit 7 to generate the mixed wave, and, after the frequency conversion at this mixing circuit 7, the unrequired frequency is eliminated by the SAW filter 8 and the transmission FM wave in the 800 MHz band is generated, therefore a smaller size and lower power consumption and a high S/N ratio are obtained.

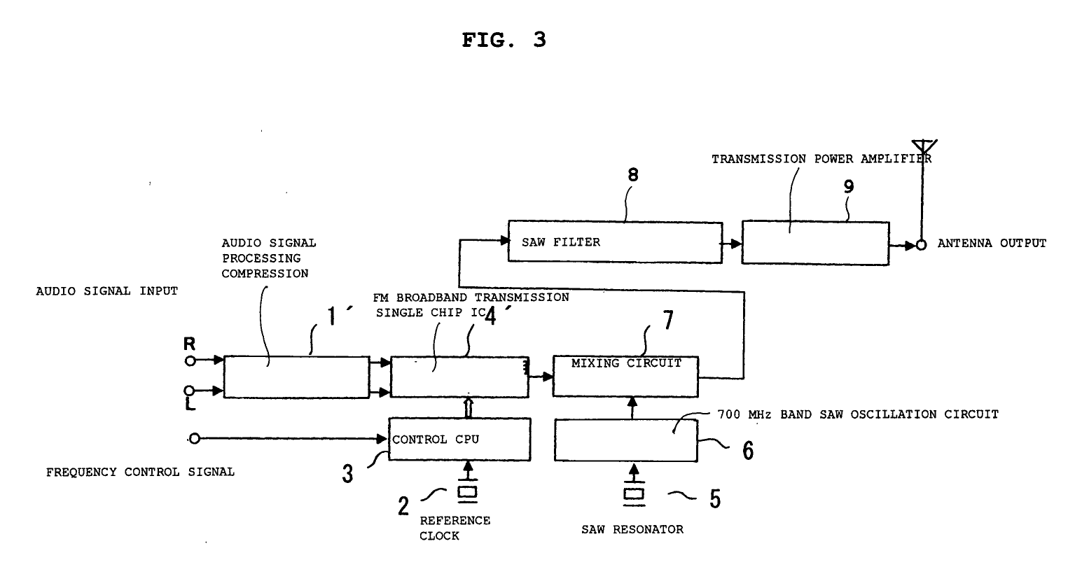

FIG. 3 is a block diagram showing an FM transmitter device according to a third embodiment of the present invention. In FIG. 3, the same notations are attached to portions the same as portions shown in FIG. 1, and the explanations thereof are omitted.

The present embodiment is an extension of the first embodiment. The FM broadband transmission single chip IC 4′ has a built-in stereo encoder (not shown). A right audio signal R and a left audio signal L are logarithmically compressed at an audio signal processing compression unit 1′, then the FM broadband transmission single chip IC 4′ receives both signals as modulated inputs and the outputs their FM frequency waves. For this reason, it can be applied to a stereo wireless device, ear monitor transmitter device, and so on.

In the above described embodiments 1-3, an explanation is given for the case when a transmitting FM wave of the 800 MHz band is generated. When a transmitting FM wave of the 200 MHz is generated, the SAW oscillating circuit 6 of the 700 MHz band may be replaced by a SAW oscillating circuit of the 100 MHz band or by a crystal oscillator of the 100 MHz band so that high frequency components (transmitting FM wave) of the 200 MHz band (178 MHz-208 MHz) are output from the SAW filter 8. In this case, it may be possible that beat sounds of the 200 MHz band are generated when the FM high frequencies of the 78 MHz-108 MHz and the reference frequency of the 100 MHz are mixed. To avoid this, it is preferable to use a reference frequency which is shifted from the 100 MHz, or to use a SWA oscillator of the 300 MHz band with a reference frequency of the 300 MHz to generate a difference frequency (192 MHz-222 MHz) by the mixing circuit 7, and then to output it from the SAW filter 8.

While the invention has been described with reference to specific embodiments chosen for purpose of illustration, it should be apparent that numerous modifications could be made thereto by those skilled in the art without departing from the basic concept and scope of the invention.

What is claimed is:

1. An FM transmitter device comprising an FM broadband transmission single chip IC which operates by receiving as its inputs a modulated wave based on an audio signal and a carrier wave setting signal, and an oscillator, wherein a non-modulated high frequency wave obtained from either of the FM broadband transmission single chip IC and the oscillator and an FM high frequency wave obtained from the other at a mixing circuit are mixed to generate a mixed wave, an unrequired frequency from this mixed wave is eliminated by a filter means, and thereby a transmission FM wave of the 200 MHz band (VHF) or the 800 MHz band (UHF) is generated.

2. An FM transmitter device as set forth in claim 1, wherein said non-modulated high frequency wave is an oscillation wave obtained from said oscillator, and said FM high frequency wave is a modulated wave obtained from the FM broadband transmission single chip IC.

3. An FM transmitter device as set forth in claim 1, wherein said non-modulated high frequency wave is a carrier wave obtained from said FM broadband transmission single chip IC not receiving as input the modulated wave, but receiving as input the carrier wave setting signal, and said FM high frequency wave is a modulated wave obtained by analog changing an additional capacity of said oscillator by the modulated wave based on an audio wave.

4. An FM transmitter device as set forth in claim 1, wherein said oscillator is a SAW resonator oscillator.

5. An FM transmitter device as set forth in claim 1, wherein said filter means is a SAW filter.
